(19) United States
(12) Patent Application Publication
(10) Pub. No.: US 2012/0094067 A1
(43) Pub. Date: Apr. 19, 2012

(54) MOISTURE-PERMEABLE WATER-PROOF SHEET FOR BUIILDING MATERIALS

(76) Inventors: Kazuhiro Nakae, Tokyo (JP); Takahiro Asako, Osaka-shi (JP); Masaharu Shida, Kouka-shi (JP); Yoshihiko Hata, Kouka-shi (JP)

(21) Appl. No.: 13/201,379

(22) PCT Filed: Jan. 29, 2010
(86) PCT No.: PCT/JP2010/051190

§ 371 Date: Dec. 27, 2011

(30) Foreign Application Priority Data
Feb. 13, 2009 (JP) 2009-030678

(51) Int. Cl. B32B 5/24; B32B 15/08; B32B 27/32; E04D 5/10; B32B 7/14

(52) U.S. Cl. 428/138; 428/198

(57) ABSTRACT

The present invention provides a moisture-permeable waterproof sheet for building materials capable of maintaining an excellent nail hole sealing performance to keep waterproof thereof even after being exposed to severe environmental conditions. The moisture-permeable waterproof sheet 1 for building materials of this invention includes a non-woven fabric layer 2 having a bulk density of 0.01 g/cm³ or more, a porous polyolefin film layer 3 arranged on an upper side of the non-woven fabric layer 2 and having waterproof properties and moisture-permeability, and an air-permeable adhesive resin layer 4 made of a plurality of linearly-formed resins 11 arranged approximately in parallel with each other in a plan view and joining the non-woven fabric layer 2 and the porous polyolefin film layer 3. A width of the linearly-formed resin of the air-permeable adhesive resin layer 4 is 0.5 to 3 mm, and a width of a gap between adjacent linearly-formed resins is 0.1 to 1 mm.

### TECHNICAL FIELD

The present invention relates to a moisture-permeable waterproof sheet for building materials excellent in waterproof properties and moisture-permeability used as, e.g., a roof base material.

### TECHNICAL BACKGROUND

Conventionally, as a roof base material for houses, an asphalt impregnated textile has been widely used. This asphalt impregnated textile is excellent in waterproof properties, excellent in dimensional stability, high in physical strength, and excellent in nail hole sealing performance around a shank of a nail driven through the textile.

However, such asphalt impregnated textile of about 20 m formed into a roll exceeds 30 kg in weight due to the impregnated asphalt, which is extremely poor in handling performance during construction work. Furthermore, the asphalt impregnated textile has almost no moisture-permeability, keeping moisture below a roof, which causes easy decay of a roofing board due to moisture absorbed in the roofing board. In addition, after construction, the asphalt impregnated textile readily deteriorates and expands/contracts by the temperature difference of the heat and cold temperatures. For this reason, the nail hole sealing performance around a shank of a nail or a tuckered portion tends to readily deteriorate over time.

On the other hand, as a roof base material as an alternative for the aforementioned conventional asphalt impregnated textile, Patent Document 1 proposes a roof base material in which a resin layer having elasticity and adhesiveness is arranged on a surface of a textile, and on top of the resin layer, another resin layer having less adhesiveness is arranged.

Furthermore, in Patent Document 2, a waterproof sheet for building materials is described, in which a non-woven fabric having an anti-slipping layer on an upper surface thereof is adhered to an upper surface of a polyethylene film having waterproof properties and moisture-permeable property, and a non-woven fabric having a swelling layer made of highly water absorbable polymer on an upper surface thereof is adhered to a lower surface of the polyethylene film.

### PRIOR ART DOCUMENTS

### Patent Documents

Patent Document 1: Japanese Unexamined Laid-open Patent Publication No. H2-269277 (JP-02-269277-A)
Patent Document 2: Japanese Unexamined Laid-open Patent Publication No. 2002-316373 (JP-2002-316373-A)

### SUMMARY OF THE INVENTION

### Problems to be Solved by the Invention

In the case of the roof base material described in the aforementioned Patent Document 1, however, the nail hole sealing performance was not sufficient in a state in which a nail is driven in.

Further, in the case of the waterproof sheet for building materials as described in the aforementioned Patent Document 2, according to a water penetration test performed in a state in which a nail is driven in, although excellent waterproof performance could be maintained without causing any water penetration even after passing 24 hours, under severe environmental conditions larger in difference between the coldest and hottest temperatures and/or between the highest and lowest humidity, the nail hole sealing performance was not always maintained at a sufficient level. Under the circumstances, it has been desired that a moisture-permeable waterproof sheet for building materials capable of maintaining sufficient nail hole sealing performance even under severer environmental conditions is developed.

The present invention was made in view of the above-mentioned technical background, and aims to provide a lightweight moisture-permeable waterproof sheet for building materials capable of maintaining excellent nail hole sealing performance to provide sufficient waterproof performance even under severer environmental conditions, and excellent in moisture-permeability.

### Means to Solve the Problems

To achieve the abovementioned objects, the present invention provides the following means.

[1] A moisture-permeable waterproof sheet for building materials, comprising:

a non-woven fabric layer having a bulk density of 0.01 g/cm³ or more;

a porous polyolefin film layer laminated on an upper side of the non-woven fabric layer and having waterproof properties and moisture-permeability; and

an air-permeable adhesive resin layer arranged to join the non-woven fabric layer and the porous polyolefin film layer, the air-permeable adhesive resin layer being made of a plurality of linearly-formed resins arranged approximately in parallel with each other in a plan view,

wherein a width of the linearly-formed resin of the air-permeable adhesive resin layer is 0.5 to 3 mm, and

wherein a width of a gap between adjacent linearly-formed resins is 0.1 to 1 mm.

[2] The moisture-permeable waterproof sheet for building materials as recited in the aforementioned Item 1, wherein at least a part of the linearly-formed resin in a thickness direction is impregnated into the non-woven fabric layer.

[3] The moisture-permeable waterproof sheet for building materials as recited in the aforementioned Item 1 or 2, wherein adjacent linearly-formed resins of the air-permeable adhesive resin layer are partially welded along a longitudinal direction of the linearly-formed resin.

[4] The moisture-permeable waterproof sheet for building materials as recited in any one of the aforementioned Items 1 to 3, wherein the air-permeable adhesive resin layer is formed by thermoplastic resin melt-extruded in a threadlike manner by an extruder.

[5] The moisture-permeable waterproof sheet for building materials as recited in any one of the aforementioned Items 1 to 4, wherein the non-woven fabric layer is a spunbonded non-woven fabric or a meltblown non-woven fabric.

[6] The moisture-permeable waterproof sheet for building materials as recited in the aforementioned Item 5, wherein the spunbonded non-woven fabric is made of polyolefin.

[7] The moisture-permeable waterproof sheet for building materials as recited in any one of the aforementioned Items 1 to 6, further comprising a porous heat shielding layer laminated on an upper side of the porous polyolefin film layer, wherein the porous heat shielding layer includes a synthetic resin film and a deposited metallic film deposited on the synthetic resin film.

[8] The moisture-permeable waterproof sheet for building materials as recited in the aforementioned Item 7, further comprising a synthetic resin protection layer laminated on an upper side of the porous heat shielding layer.

[9] The moisture-permeable waterproof sheet for building materials as recited in any one of the aforementioned Items 1 to 6, wherein;

a thermoplastic resin film is laminated on an upper side of the porous polyolefin film layer,

a deposited metallic film made of a glossy metallic material is provided on an upper side of the thermoplastic resin film,

a surface protection layer in which light-blocking particles are mixed in a transparent thermoplastic resin is laminated on an upper side of the deposited metallic film, and

a plurality of through-holes are formed so as to penetrate through a heat-shielding and anti-glare functional layer constituted by the thermoplastic resin film, the deposited metallic film, and the surface protection layer.

[10] The moisture-permeable waterproof sheet for building materials as recited in the aforementioned Item 9, wherein an average particle diameter of the light-blocking particle is 5 to 300 nm.

[11] The moisture-permeable waterproof sheet for building materials as recited in the aforementioned Item 9 or 10, wherein the light-blocking particle is an oxidized titanium particle.

[12] The moisture-permeable waterproof sheet for building materials as recited in any one of the aforementioned Items 9 to 11, wherein the surface protection layer contains 0.1 to 1.5 mass parts of the light-blocking particles with respect to 100 mass parts of the thermoplastic resin.

[13] The moisture-permeable waterproof sheet for building materials as recited in any one of the aforementioned Items 9 to 12, wherein a hole diameter of the through-hole is 0.3 to 0.7 mm, and wherein the through-holes are distributed at a rate of 500,000 to 1,000,000 holes/m².

### Effect of the Invention

According to the invention [1], the sheet is excellent in lightweight properties since no heavy asphalt is used. Furthermore, since a porous polyolefin film layer having waterproof properties and moisture-permeability is arranged on the upper side of the non-woven fabric layer, sufficient waterproof properties and sufficient moisture-permeability for a moisture-permeable waterproof sheet can be secured. Also, since a non-woven fabric layer is provided, the porous polyolefin film layer is assuredly prevented from being damaged by, e.g., the contact with a roofing board at the time of construction. Furthermore, in addition to that the non-woven fabric layer has a bulk density of 0.01 g/cm³ or more, the adhesive resin layer is made of a plurality of linearly-formed resins arranged approximately in parallel with each other in a plan view, and that at least a part of the linearly-formed resin in the thickness direction can be easily impregnated into the non-woven layer. As a result, the resin impregnated non-woven fabric can sufficiently adhere to the driven-in nail, causing a strong pressing force against the driven-in nail, which in turn results in sufficient waterproof properties (excellent nail sealing performance can be obtained). Furthermore, since the width of the linearly-formed resin of the air-permeable adhesive resin layer is 0.5 to 3 mm and that the width of the gap between adjacent linearly-formed resins is 0.1 to 1 mm, the driven-in nail can be pressed more strongly, which further enhances the certainty of the water sealing effect and secures more excellent moisture-permeability.

According to the invention [2], since at least a part of the linearly-formed resin in a thickness direction is impregnated into the non-woven fabric layer, the resin impregnated non-woven fabric sufficiently adheres to the driven-in nail, causing a stronger pressing force to the driven-in nail, which in turn results in assured water sealing.

According to the invention [3], since the adjacent linearly-formed resins of the air-permeable adhesive resin layer are partially welded along a longitudinal direction of the linearly-formed resin, the driven-in nail can be pressed even more strongly, which further improves the certainty of the water sealing effect.

According to the invention [4], since the air-permeable adhesive resin layer is formed by thermoplastic resins melt-extruded in a threadlike manner by an extruder, an even more uniform linearly-formed resin can be formed, resulting in sufficient adhesive strength.

According to the invention [5], since the non-woven fabric layer is made of a spunbonded non-woven fabric or a meltblown non-woven fabric, the certainty of the water sealing effect can be further improved.

According to the invention [6], since the spunbounded non-woven fabric is made of polyolefin and the polyolefin is hydrophobic, the certainty of the water sealing effect can be further improved.

According to the invention [7], since a porous heat shielding layer is laminated on an upper side of the porous polyolefin film layer, wherein the porous heat shielding layer includes a synthetic resin film and a deposited metallic film deposited on the synthetic resin film, sufficient heat shielding performance can be obtained.

According to the invention [8], since the synthetic resin protection layer is arranged on an upper side of the porous heat shielding layer, possible damages, etc., to the heat shielding layer can be sufficiently prevented, which provides sufficient heat shielding performance for a long period of time.

According to the invention [9], the deposited metallic film of the heat shielding and anti-glare functional layer sufficiently reflects infrared rays and the specular reflection light of visible light reflected by the deposited metallic film can be scattered with the existence of the light-blocking particles and the through-holes of the surface protection layer while the specular reflection light passes through the surface protection layer, and therefore the outgoing radiation of the specular reflection light of visible light from the deposited metallic film can be reduced. In other words, according to this moisture-permeable waterproof sheet for building materials, while securing moisture-permeation and waterproof performance, infrared rays can be sufficiently reflected, and outgoing radiation of the specular reflection light of visible light can be sufficiently reflected. The reduced outgoing radiation of the specular reflection light of visible light can sufficiently control glare of the sunbeam reflection to the worker, which can sufficiently improve the worker's operational safety.

According to the invention [10], since the average particle diameter of the light-blocking particle is 5 to 300 nm, the outgoing radiation of the specular reflection light of visible light can be sufficiently controlled to sufficiently control glare of sunbeam reflections.

According to the invention [11], since the light-blocking particle is an oxidized titanium particle, the outgoing radiation of specular reflection light of visible light can be further controlled.

According to the invention [12], since the surface protection layer contains 0.1 to 1.5 mass parts of the light-blocking particles with respect to 100 mass parts of the thermoplastic resin, the outgoing radiation of specular reflection light of visible light can be sufficiently controlled when the content is 0.1 mass parts or more, and infrared rays can be sufficiently reflected when the content is 1.5 mass parts or less.

According to the invention [13], since the hole diameter of the through-hole is 0.3 to 0.7 mm and the through-holes are distributed at a rate of 50 to 1,000,000 holes/m², sufficient moisture-permeation function can be obtained, and sufficiently excellent infrared reflection function can be obtained.

### BRIEF DESCRIPTION OF THE DRAWINGS

FIG. 1 is a schematic cross-sectional view showing a moisture-permeable waterproof sheet for building materials according to an embodiment of the present invention.

FIG. 2 is a schematic top view showing an air-permeable adhesive resin layer of the moisture-permeable waterproof sheet for building materials shown in FIG. 1.

FIG. 3 is a schematic cross-sectional view showing a moisture-permeable waterproof sheet for building materials according to another embodiment of the present invention.

FIG. 4 is a perspective view showing the moisture-permeable waterproof sheet for building materials shown in FIG. 3 in a broken-down manner (the air-permeable adhesive resin layer 4 is not illustrated).

### BEST MODE FOR CARRYING OUT THE INVENTION

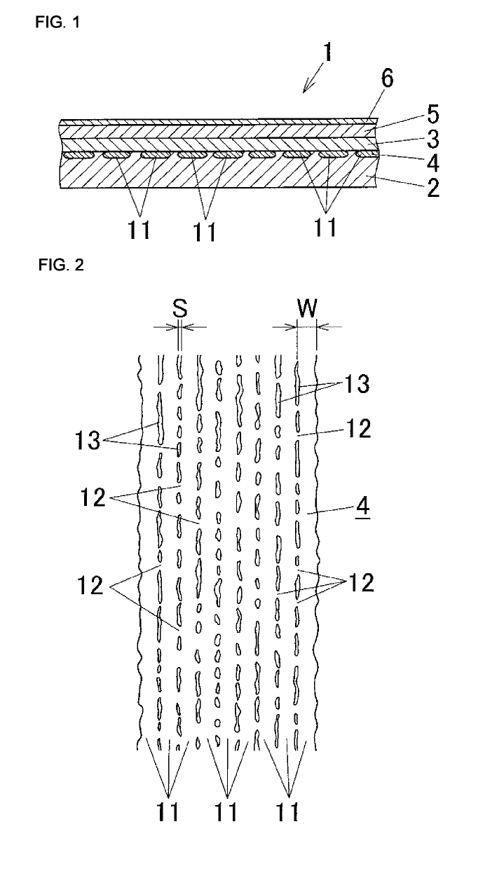

An embodiment of a moisture-permeable waterproof sheet 1 for building materials according to the present invention is shown in FIG. 1. The moisture-permeable waterproof sheet 1 for building materials of this embodiment is a sheet especially suitably used for a roof base material. The moisture-permeable waterproof sheet 1 for building materials is a laminated sheet member in which a porous polyolefin film layer 3 having waterproof properties and moisture permeability is laminated on an upper surface of a non-woven fabric layer 2 having a bulk density of 0.01 g/cm³ or more via an air-permeable adhesive resin layer 4. As shown in FIG. 2, the air-permeable adhesive resin layer 4 is an air-permeable adhesive resin layer in which a number of linearly-formed resins 11 are arranged approximately in parallel with each other in a plan view. At least a part of the linearly-formed resin 11 in a thickness direction thereof is impregnated into the non-woven fabric layer 2.

In this embodiment, as shown in FIG. 2, the adjacent linearly-formed resins 11 of the air-permeable adhesive resin layer 4 are partially welded along a longitudinal direction of the linearly-formed resin, and the welded portions 12 are arranged in a scattered manner in a plan view. In other words, the adhesive resin layer 4 is formed in an approximately mesh-shape in a plan view. Such approximately mesh-shape is created by subtle differences of the degree of impregnation of the resin on the surface of the non-woven fabric layer 2 even if the linearly-formed resins 11 are arranged in approximately parallel.

Furthermore, in the embodiment, a porous heat shielding layer 5 in which a deposited metallic film is formed on a synthetic resin film is laminated on an upper surface of the porous polyolefin film layer 3. The porousness of the heat shielding layer 5 is given by physically forming a number of micropores through a sheet (metalized synthetic resin film) which will constitute the heat shielding layer 5. Furthermore, a synthetic resin protection layer 6 is formed on an upper surface of the porous heat shielding layer 5. In other words, the synthetic resin protection layer 6 is formed on an upper surface of the deposited metallic layer existing on a surface layer of the porous heat shielding layer 5.

In the present invention, the porous polyolefin film layer 3 has waterproof properties and moisture-permeability, and plays a principle role in exerting waterproof properties and moisture-permeability required for a moisture-permeable waterproof sheet 1 for building materials. The porous polyolefin film layer 3 is not specifically limited, but can be preferably constituted by a waterproof and moisture-permeable porous polyethylene film or a waterproof and moisture-permeable porous polypropylene film. Among them, it is more preferable that the porous polyolefin film is constituted by a porous polyethylene film, which can further increase the moisture-permeability. The porousness of the porous polyolefin film layer 3 can be given by, for example, mixing inorganic particles (e.g., calcium carbonate). That is, for example, at the time of manufacturing a porous polyolefin film, minute cracks are generated at the existing positions of the inorganic particles (e.g., calcium carbonate), which in turn forms minute holes which give moisture-permeability while maintaining waterproof properties. It is preferable that the particle diameter of the inorganic particle is 5 μm or less.

It is preferable that the thickness of the porous polyolefin film layer 3 falls within the range of 20 to 100 μm. When the thickness is 20 μm or more, it becomes possible to exert an elastic force sufficient to fill a gap (nail hole) generated between a nail and the film at the time of driving in the nail during construction, resulting in sufficient nail hole sealing performance. When it is 100 μm or less, it becomes possible to attain sufficiently lightweight properties.

The moisture-permeability of the porous polyolefin film layers 3 and 5 is preferably 1,000 g/m²·24 hr or more. In this case, sufficient moisture permeability required for a moisture-permeable waterproof sheet 1 for building materials can be secured, which sufficiently prevents a decay of a roofing board due to the absorbed moisture.

As a non-woven fabric constituting the non-woven fabric 2, a non-woven fabric having a bulk density of 0.01 g/cm³ or more is used. If the bulk density is less than 0.01 g/cm³, the driven-in nail cannot be pressed sufficiently, resulting in insufficient waterproof performance. Above all, it is preferable to use a non-woven fabric having a bulk density of 0.01 to 0.05 g/cm³. It is especially preferable to use a non-woven fabric having a bulk density of 0.02 to 0.03 g/cm³.

The thickness of the non-woven fabric layer 2 is preferably set to fall within the range of 0.5 to 3 mm. Setting the thickness to 0.5 mm or more enables sufficient pressing of the driven-in nail, and setting the thickness to 3 mm or less enables cost reduction and more effective weight saving.

As the non-woven fabric layer 2, although not specifically limited, a spunbonded non-woven fabric, a meltblown non-woven fabric, and a needle punch non-woven fabric can be exemplified. Among them, it is preferable to use a spunbonded non-woven fabric or a meltblown non-woven fabric from the view point of further enhancing the certainty of the water sealing effect. It is especially preferable to use a spunbonded non-woven fabric made of polypropylene.

A width W of the linearly-formed resin 11 of the air-permeable adhesive resin layer 4 is set to 0.5 to 3 mm (see FIG. 2). If the width is less than 0.5 mm, the driven-in nail cannot be sufficiently pressed, resulting in insufficient water sealing effect, and if the width exceeds 3 mm, sufficient moisture-permeability cannot be obtained.

The width S of the gap 13 between the adjacent linearly-formed resins 11 and 11 of the air-permeable adhesive resin layer 4 is set to 0.1 to 1 mm (see FIG. 2). If the width is less than 0.1 mm, sufficient moisture-permeability cannot be obtained, and if the width exceeds 1 mm, the driven-in nail cannot be sufficiently pressed, resulting in insufficient water sealing effect. The width S of the gap 13 between the adjacent linearly-formed resins 11 and 11 is preferably set to fall within the range of 0.2 to 0.7 mm.

Further, an amount (applied amount) of the air-permeable adhesive resin layer 4 is preferably set to 30 to 150 g/m². By setting the amount to 30 g/m² or more, the resin can be more easily impregnated into the non-woven fabric 2, and by setting the amount to 150 g/m² or less, sufficient moisture-permeability can be obtained. Among others, it is especially preferable to set the amount (applied amount) of the air-permeable adhesive resin layer 4 so as to fall within the range of 30 to 130 g/m².

The air-permeable adhesive resin layer 4 is preferably formed using thermoplastic resin melt-extruded in a threadlike manner by an extruder. In this case, a more uniformly linearly-formed resin 11 can be formed, which results in sufficient adhesive strength. For example, the moisture-permeable waterproof sheet 1 for building materials of the present invention can be manufactured, after applying thermoplastic resin melt-extruded in a threadlike manner by an extruder on the non-woven fabric layer 2, by arranging the porous polyolefin film layer 3 thereon and then pressing them by and between rolls.

As the resin constituting the air-permeable adhesive resin layer 4, although not specifically limited, olefin-series resins, such as, e.g., polyethylene, polypropylene, and ethylene-vinylacetate copolymer can be exemplified.

As the porous heat shielding layer 5, although not specifically limited, a porous film in which a deposited metallic layer is deposited on a synthetic resin film can be exemplified. As the synthetic resin film, although not especially limited, a polyethylene film, a polypropylene film, and a polyester film can be exemplified.

As the synthetic resin protection layer 6, although not specifically limited, a polyethylene layer and a polypropylene layer can be exemplified.

The integration of the porous polyolefin film layer 3 and the porous heat shield payer 5 and the integration of the porous heat shielding layer 5 and the synthetic resin protection layer 6 are both preferably done by adhesion, but not especially limited to the means. The adhesion method is not especially limited as long as it can adhere them while maintaining air-permeability, and can be, for example, a dry lamination method, a wet lamination method, or a heat lamination method. The type of adhesive agent is not specifically limited.

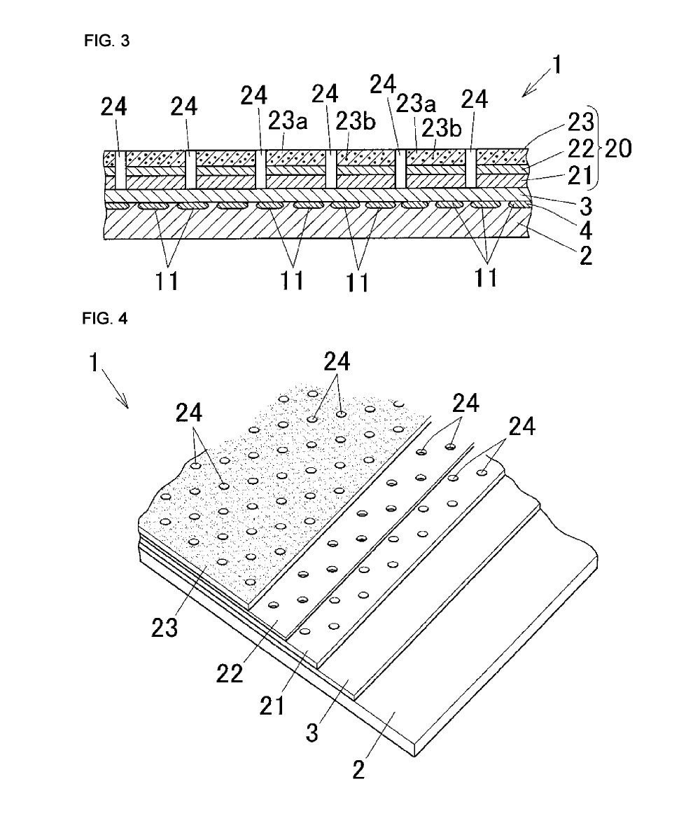

It can be configured such that a heat shielding and anti-glare functional layer 20 is laminated in place of the porous heat shielding layer 5 and the synthetic resin protection layer 6 of the moisture-permeable waterproof sheet 1 for building materials shown in FIG. 1 (see FIG. 3). In this moisture-permeable waterproof sheet 1 for building materials shown in FIG. 3, the non-woven fabric layer 2, the porous polyolefin film layer 3, and the air-permeable adhesive resin layer 4 are the same in structure as those of the moisture-permeable waterproof sheet 1 for building materials shown in FIG. 1, and therefore the descriptions will be omitted.

The heat shielding and anti-glare functional layer 20 is provided with a thermoplastic resin substrate film 21 laminated on an upper side of the porous polyolefin film layer 3, a deposited metallic film 22 in which glossy metallic materials are deposited on an upper side of the film 21, and a surface protection layer 23 which is a laminated layer formed on an upper side of the deposited metallic film 22 in which light-blocking particles 23b are mixed in a transparent thermoplastic resin 23a. A number of through-holes 24 penetrating through the heat shielding and anti-glare functional layer 20 in the thickness direction thereof are formed (see FIGS. 3 and 4).

In the moisture-permeable waterproof sheet 1 for building materials shown in FIG. 3, infrared rays can be sufficiently reflected by the deposited metallic film 22 of the heat shielding and anti-glare functional layer 20, and the outgoing radiation of regular specular reflection light of visible light from the deposited metallic film can be reduced by the existence of the light-blocking particle 23b and through-holes 24 of the surface protection layer 23. In other words, according to the moisture-permeable waterproof sheet 1 for building materials, while securing the moisture-permeating and waterproof performance, it is possible to sufficiently reflect infrared rays, and reduce outgoing radiation of the specular reflection light of visible light. The reduction of the outgoing radiation of the specular reflection light of visible light can sufficient control glare of the sunbeam reflection to workers, resulting in sufficiently improved operational safeness for workers.

The heat shielding and anti-glare functional layer 20 can be formed, for example, in the following manner. That is, glossy metallic material is deposited on one surface of a thermoplastic resin substrate film 21 to form a deposited metallic film 22. As the thermoplastic resin substrate film 21, a stretched polypropylene film (with a thickness of, e.g., 20 μm) can be exemplified. As the glossy metallic material, although not specifically limited, it is preferably to use aluminum from the view point that aluminum is excellent in reflectivity and can be easily deposited. The thickness of the deposited metallic film 22 is not specifically limited, but can be, e.g., 45 nm.

Next, a surface protection layer 23 in which light-blocking particle 23b are mixed in colorless and transparent thermoplastic resin 23a is laminated on a surface of the deposited metallic film 22 to obtain the heat shielding and anti-glare functional layer 20. As the thermoplastic resin 23a, although not specifically limited, LLDPE (linearly-formed low density polyethylene), LDPE (low density polyethylene), PET (polyethylene terephthalate), and PP (polypropylene) can be exemplified.

Next, a number of through-holes 24 are perforated into the heat shielding and anti-glare functional layer 20 at predetermined intervals (see FIG. 4). Thereafter, the porous polyolefin film layer 3, which is the aforementioned laminated sheet member (i.e., a laminated member in which the porous polyolefin film layer 3 having waterproof properties and moisture permeability is laminated on the upper surface of the non-woven fabric layer 2 having a bulk density of 0.01 g/cm³ or more via the aforementioned air-permeable adhesive resin layer 4), and the thermoplastic resin substrate film 21 of the heat shielding and anti-glare functional layer 20 are integrally laminated by a dry lamination method via hot melt adhesive material (olefin series, rubber series, EVA series, acryl series, etc.) to thereby obtain the moisture-permeable waterproof sheet 1 for building materials of the present invention (see FIGS. 3 and 4).

As the light-blocking particle 23b, although not specifically limited, oxidized titanium particles and calcium carbonate particles can be exemplified. Among them, oxidized titanium particles is preferably used. The surface protection layer 23 is preferably constituted such that 0.1 to 1.5 mass parts (more preferably 0.2 to 1.0 mass parts) of oxidized titanium particles 23b is mixed with respect to 100 mass parts of the thermoplastic resin 23a. When it is 0.1 mass parts or more, outgoing radiation of specular reflection light of visible light can be sufficiently controlled. When it is 1.5 mass parts or less, infrared radiation can be sufficiently reflected.

It is preferable that an average particle diameter of the light-blocking particle 23b is 5 to 300 nm. In this case, the outgoing radiation of specular reflection light of visible light can be sufficiently controlled.

It is preferable that a thickness of the surface protection layer 23 is 10 to 15 μm. When the thickness is 10 μm or more, the deposited metallic film 22 can be sufficiently protected. When the thickness is 15 μm or less, infrared rays can be sufficiently reflected.

It is preferable that a hole diameter of the through-hole 24 is 0.3 to 0.7 mm, more preferably 0.4 to 0.6 mm. Also, the distribution rate of the through-holes 24 is preferably set to 500,000 to 1,000,000 holes/m², more preferably 500,000 to 900,000 holes/m². It is also preferable that an opening (area) rate of the heat shielding and anti-glare functional layer 20 is set to 10 to 15%. If the hole diameter of the through-hole is less than 0.3 mm or the distribution rate of the through-holes is less than 500,000 holes/m², it becomes difficult to obtain sufficient moisture-permeability. If the hole diameter of the through-hole exceeds 0.7 mm or the distribution rate of the through-holes exceeds 1,000,000 holes/m², it becomes difficult to obtain sufficient infrared ray reflection function.

In the aforementioned embodiments, although it is configured such that the linearly-formed resins 11 constituting the air-permeable adhesive resin layer 4 extend in one direction (see FIG. 2), but not limited to such a configuration, and can be configured, for example, such that the air-permeable adhesive resin layer 4 is formed with linearly-formed resins extending in one direction and linearly-formed resins extending in a direction approximately perpendicular to the one direction (cross-configuration). The scope of claims of this application covers a moisture-permeable waterproof sheet for building materials according to an embodiment having the aforementioned cross-configuration.

### Example

Next, concrete examples of the present invention will be explained, but it should be understood that the present invention is not limited to these examples.

### Example 1

A porous polyethylene film 3 having waterproof properties and moisture-permeability which was 7,000 g/m²·24 hr in moisture-permeability and 30 μm in thickness, a porous film (porous heat shielding layer) 5 in which an aluminum deposited layer was formed on a polypropylene film having a thickness of 20 μm, and a weathering stabilizer-contained weatherproof polyethylene film (synthetic resin protection layer) 6 having a thickness of 12 μm were stacked in this order and integrally adhered with each other with a dry lamination method to obtain a surface member. The porous heat shielding layer 5 and the synthetic resin protection layer 6 constitute a heat shielding and anti-glare functional layer.

Next, after applying a number of thermoplastic resins melt-extruded in a threadlike manner by an extruder onto a polypropylene spunbonded non-woven fabric layer 2 having a bulk density of 0.022 g/m³ and a thickness of 0.7 mm at a rate of 70 g/m², the surface member was arranged thereon with the porous polyolefin film layer 3 facing downward. Then, these were pressed by and between rolls to obtain a moisture-permeable waterproof sheet 1 for building materials shown in FIG. 1.

In the obtained moisture-permeable waterproof sheet for building material, the width W of the linearly-formed resin 11 of the air-permeable adhesive resin layer 4 was 1.5 mm, and the gap S between the adjacent linearly-formed resins 11 was 0.5 mm, and as shown in FIG. 2, the adhesive resin layer 4 was configured such that adjacent linearly-formed resins 11 were partially welded in the longitudinal direction.

### Examples 2 and 3, Comparative Examples 1 and 2

Moisture-permeable waterproof sheets for building materials having the structure shown in Table 1 were obtained in the same manner as in Example 1 except that materials and designs were set to the conditions shown in Table 1.

Each of the moisture-permeable waterproof sheets for building materials obtained as described above was evaluated based on the following test methods. The results are shown in Table 1.

<Moisture-Permeability Evaluation Method>

Moisture-permeability (g/m²·24 hr) of each moisture-permeable waterproof sheet for building materials was evaluated in accordance with the “A Method” of 4.1 of JIS L1099 (moisture-permeability test method for textile products).

<Nail Hole Sealing Performance Evaluation Method>

A moisture-permeable waterproof sheet for building materials was repeatedly subjected to a step of placing the moisture-permeable waterproof sheet for building materials under a cycle of environmental conditions by five times, each cycle of environmental conditions being: 80° C.×20% RH×15.5 hours; −40° C.×0% RH×7.5 hours; 80° C.×95% RH×15.5 hours; and then −40° C.×0% RH×7.5 hours.

Next, the moisture-permeable waterproof sheet for building materials subjected to five cycles was arranged on a plywood having a thickness of 12 mm with the anti-slipping layer facing upward, and nails for Colonial roof tiles (length: 30 mm, maximum diameter: 3.3 mm, minimum diameter: 2.9 mm, a gap between the maximum diameter portion and the maximum diameter portion: 1.3 mm) were driven in. On top of that, a polyvinyl chloride pipe was set up with the bottom portion sealed in a watertight manner with sealing material. Thereafter, the pipe was filled with water and the upper end opening portion thereof was sealed with a rubber plug to apply a hydraulic head pressure of 150 mm. After the lapse of 24 hours, the decreased amount of water in the pipe was measured (mL). When the decreased amount of water was 1.0 mL or less, it was evaluated as “Pass.” The test was conducted for five samples in each of Examples and Comparative Examples, and the pass rate is shown in Table 1. For example, “5/5” denotes that the nail hole sealing performance test was evaluated as “pass” for all five samples.

As it is apparent from Table 1, the moisture-permeable waterproof sheets for building materials of Examples to 3 of the present invention had excellent moisture-permeability, and even after having being subjected to severe environmental conditions, the nail hole sealing performance was excellent and sufficient waterproof performance was obtained. Also, these moisture-permeable waterproof sheets for building materials of Examples 1 to 3 were high in infrared ray reflection rate to sufficiently reflect infrared rays, which was excellent in heat shielding performance. At the same time, the specular reflection rate of visible light was very small, and therefore glare from sunbeam reflection to workers can be sufficiently controlled.

On the other hand, in Comparative Example 1 in which the gap S between the adjacent linearly-formed resins was smaller than the range defied by the present invention, sufficient moisture-permeability could not be obtained. Also, in Comparative Example 2 in which the gap S between the adjacent linearly-formed resins was larger than the range defined by the present invention, the nail hole sealing performance was insufficient after having being subjected to severe environmental conditions.

TABLE 1

| | | | | | Comp. | Comp. |
|---|---|---|---|---|---|---|
| | | Ex. 1 | Ex. 2 | Ex. 3 | Ex. 1 | Ex. 2 |
| Moisture-Permeability of porous | | 7,000 | 7,000 | 7,000 | 7,000 | 7,000 |
| polyethylene film (g/m² · 24 hr) | | | | | | |
| Linearly- | Width W (mm) | 1.5 | 1.0 | 2.0 | 2.0 | 0.7 |
| formed | Gap S (mm) | 0.5 | 0.5 | 0.7 | 0.05 | 2.0 |
| resin | Applied amount (g/m²) | 70 | 50 | 70 | 150 | 50 |
| Non-woven | Bulk density (g/m³) | 0.022 | 0.022 | 0.022 | 0.022 | 0.022 |
| fabric | Thickness (mm) | 0.7 | 0.7 | 1.0 | 1.0 | 0.7 |
| layer | | | | | | |
| Evaluation | Moisture-Permeability | 2,024 | 2,355 | 2,838 | 421 | 4,827 |
| | of moisture-permeable | | | | | |
| | waterproof sheet for | | | | | |
| | building materials | | | | | |
| | (g/m² · 24 hr) | | | | | |
| | Nail hole Sealing | 5/5 | 5/5 | 5/5 | 5/5 | 1/5 |
| | performance (pass | | | | | |
| | rate) | | | | | |
| | Infrared radiation | 80 | — | — | — | — |
| | reflection rate (%) | | | | | |
| | Visible light | 8 | — | — | — | — |
| | specular reflection | | | | | |
| | rate (%) | | | | | |

### Example 4

A heat shielding and anti-glare functional layer 20 (heat shielding and anti-glare functional layer) was obtained by integrally adhering a deposited layer 22 side of a heat shielding film in which an aluminum deposited layer 22 having a thickness of 45 nm is deposited on a polypropylene film 21 having a thickness of 20 μm to a surface protection film 23 (surface protection layer) having a thickness of 12 μm in which 0.6 mass parts of oxidized titanium particles 23b having an average particle diameter of 210 nm with respect to 100 mass parts of LLDPE 23a by a hot melt lamination method, and thereafter perforating through-holes 24 having a diameter of 0.5 mm penetrating through the layered sheet in the thickness direction thereof at a distribution rate of 600,000 holes/m² and an opening area rate of 11.8%.

One of the surfaces of the waterproof and moisture-permeable porous polyolefin film 3 having a thickness of 30 μm and moisture-permeability of 7,000 g/m²·24 hr was integrally adhered to the polypropylene film 21 side of the heat shielding and anti-glare functional layer 20 by a dry lamination method with olefin adhesive material to obtain a surface member.

Next, a number of polyethylene resins melt-extruded in a threadlike manner by an extruder were applied on an upper surface of a polypropylene spunbonded non-woven fabric layer 2 having a bulk density of 0.022 g/m³ and a thickness of 0.7 mm at a rate of 70 g/m² in applied amount. Thereafter, on top of it, the surface member was arranged with the porous polyethylene film 3 facing downward, and then pressed by and between rolls. Thus, a moisture-permeable waterproof sheet 1 for building materials shown in FIG. 3 was obtained.

In the obtained moisture-permeable waterproof sheet 1 for building materials, the width W of the linearly-formed resin 11 of the air-permeable adhesive resin layer 4 was 1.5 mm, the gap S between the adjacent linearly-formed resins 11 was 0.5 mm. As shown in FIG. 2, the adhesive resin layer 4 was configured such that the adjacent linearly-formed resins were partially welded with each other along the length direction thereof.

### Examples 5 to 8

Moisture-permeable waterproof sheets 1 for building materials having the structure shown in Table 3 were obtained in the same manner as in Example 4 except that materials and designs were set to the conditions shown in Table 2.

For each of the moisture-permeable waterproof sheets for building materials in Examples 4 to 8 obtained as described above, evaluation was conducted in accordance with the aforementioned moisture-permeability evaluation method and nail hole sealing performance evaluation method, and also the infrared radiation reflection rate and the specular reflection rate of visible light were measured in accordance with the aforementioned measurement method. The results are shown in Table 2.

<Infrared Radiation Ray Reflection Rate Measurement Method>

Each moisture-permeable waterproof sheet for building materials was cut into a square shape of 3 cm×3 cm, which was used as a measurement sample. This measurement was conducted using an infrared spectroscopy integrating sphere by a Fourier transform infrared spectroscopy method (FT-IR) to measure the reflection rate. The measurement area was in a range of φ10 mm of the central portion of the measurement sample. Reflection rates were measured twice (both scattering reflection and specular reflection) in the perpendicular direction at the central portion of the measurement material and the average value of the two measurements was used as a measured value. The details of the measurement conditions were as follows:
Measurement device: IFS-66v/S (FT-IR made by Bruker Co., vacuum optical system)

Source of light: Glover (SiC)

Analyzer: MCT (HgCdTe)

Beam Splitter Ge/KBr

### Measured Conditions

Resolving power: 4 cm⁻¹

Cumulated number: 512 times

Zero filling: 2 times

Apodization: triangle

Measured region: 5,000 to 715 cm⁻¹ (2 to 14 μm)

Measured temperature: room temperature (about 25° C.)
Auxiliary device: Transmittance rate and reflection rate measurement integrating sphere
   Reference sample: diffuse-gold (made by Labsphere Co.)
[Diffuse reflection component]
Au deposited layer (evaluated)
[specular reflection component]
   Incidence angle: 10° C.
   Spot diameter of light: about T10 mm
   Repeat accuracy: about ±1%
   Specular trap was used. [At the time of measuring the diffuse reflection component]

<Visible Light Specular Reflection Rate Measurement Method>

Each moisture-permeable waterproof sheet for building materials was cut into a square shape of 3 cm×3 cm, which was used as a measurement sample. This measurement was conducted using an integrating sphere to measure the specular reflection rate. The measurement area was in a range of φ10 mm of the central portion of the measurement material.
Measurement device: UV3101 PC type self-recording spectrophotometer
   (made by Shimadzu Corporation)

Slit width: 30 nm

Slit program: Normal

Measured speed: Slow (about 4 points/sec)

Light source: halogen lamp (340 nm or more)
Deuterium lamp (340 nm or less)

Detector: PMT (860 nm or less)
PbS (860 nm or more)

Sub white board: BaSO₄

Incidence angle: 7°

Standard while board: made by Labsphere, Inc.
[Diffuse reflection component]

Al deposited mirror: evaluated by Toray Industries, Inc.
[Specular reflection component]

Auxiliary device: large sampling room (60φ)
[transmittance spectrum]
Large integrating sphere (150φ)
[reflection rate spectrum]
Data processing device
(MBC17JH20/PC9801)

TABLE 2

| | | | | Ex. 4 | Ex. 5 | Ex. 6 | Ex. 7 | Ex. 8 |
|---|---|---|---|---|---|---|---|---|
| Heat Shielding and | Surface | Composition | LLDPE | 100 | 100 | — | 100 | — |
| anti-glare layer | Protection | | LDPE | — | — | 100 | — | 100 |
| | Layer | | Oxidized | 0.6 | 1.0 | 1.0 | 0.2 | 0.2 |
| | | | Titanium | | | | | |
| | | | (210 nm | | | | | |
| | | | diameter) | | | | | |

| | | | | | | |
|---|---|---|---|---|---|---|
| | Thickness | 12 | 12 | 12 | 12 | 12 |
| | (μm) | | | | | |
| Metallic | Thickness | 45 | 45 | 45 | 45 | 45 |
| deposited | (nm) | | | | | |
| layer | | | | | | |
| Base | Thickness | 20 | 20 | 20 | 20 | 20 |
| material | (μm) | | | | | |
| film (PP) | | | | | | |
| Through- | Hole | 0.5 | 0.6 | 0.4 | 0.6 | 0.36 |
| hole | diameter | | | | | |
| | (diameter) | | | | | |
| | (mm) | | | | | |
| | Distribution | 60 | 50 | 90 | 50 | 100 |
| | rate | | | | | |
| | (10,000/m²) | | | | | |
| | Opening | 11.8 | 14.1 | 11.3 | 14.1 | 10.2 |
| | area rate | | | | | |
| | (%) | | | | | |

| Moisture-Permeability of porous | | 7,000 | 7,000 | 7,000 | 7,000 | 7,000 |
|---|---|---|---|---|---|---|
| polyethylene film (g/m² · 24 hr) | | | | | | |
| Linearly- | Width W (mm) | 1.5 | 1.0 | 2.0 | 1.5 | 1.5 |
| formed | Gap S (mm) | 0.5 | 0.5 | 0.7 | 0.5 | 0.5 |
| resin | Applied Amount (g/m²) | 70 | 50 | 70 | 70 | 70 |
| Non-woven | Bulk Density (g/m³) | 0.022 | 0.022 | 0.022 | 0.022 | 0.022 |
| fabric | Thickness (mm) | 0.7 | 0.7 | 1.0 | 0.7 | 0.7 |
| layer | | | | | | |
| Evaluation | Moisture-permeability | 2003 | 2401 | 2120 | 2306 | 1732 |
| | of moisture-permeable | | | | | |
| | waterproof sheet for | | | | | |
| | building materials | | | | | |
| | (g/m² · 24 hr) | | | | | |
| | Nail hole sealing | 5/5 | 5/5 | 5/5 | 5/5 | 5/5 |
| | performance (pass rate) | | | | | |
| | Infrared radiation | 82 | 81 | 78 | 84 | 83 |
| | reflection rate (%) | | | | | |
| | Visible light specular | 10 | 7 | 7 | 17 | 17 |
| | reflection rate (%) | | | | | |

As it is apparent from Table 2, in the moisture-permeable waterproof sheets for building materials of Examples to 8 of the present invention, excellent moisture-permeability was obtained, and even after having being subjected to severe environmental conditions, the nail hole sealing performance was excellent and sufficient waterproof performance was obtained. Further, the moisture-permeable waterproof sheets for building materials of Examples 4 to 8 were high in infrared ray reflection rate to sufficiently reflect infrared rays, which was excellent in heat shielding performance. At the same time, the specular reflection rate of visible light was very small, and therefore glare from sunbeam reflection to workers can be sufficiently controlled.

The present invention claims priority to Japanese Patent Application No. 2009-30678 filed on Feb. 13, 2009, the entire disclosure of which is incorporated herein by reference in its entirety.

### INDUSTRIAL APPLICABILITY

A moisture-permeable waterproof sheet for building materials of the present invention can be used for, for example, a base material for building materials, and preferably used for a roof base material.

### DESCRIPTION OF THE REFERENCE NUMERALS

1 . . . moisture-permeable waterproof sheet for building materials
2 . . . non-woven fabric layer
3 . . . porous polyolefin film layer
4 . . . air-permeable adhesive resin layer
5 . . . porous heat shielding layer
6 . . . synthetic resin protection layer
11 . . . linearly-formed resin
12 . . . welded portion
13 . . . gap between adjacent linearly-formed resins
20 . . . heat shielding and anti-glare functional layer
21 . . . thermoplastic resin film
22 . . . deposited metallic film
23 . . . surface protection layer
23a . . . thermoplastic resin
23b . . . light-blocking particle
24 . . . through-holes
S . . . width of gap
W . . . width between linearly-formed resins

1. A moisture-permeable waterproof sheet for building materials, comprising:
a non-woven fabric layer having a bulk density of 0.01 to 0.05 g/cm³;
a porous polyolefin film layer laminated on an upper side of the non-woven fabric layer and having waterproof properties and moisture-permeability; and
an air-permeable adhesive resin layer arranged to join the non-woven fabric layer and the porous polyolefin film layer, the air-permeable adhesive resin layer being made of a plurality of linearly-formed resins arranged approximately in parallel with each other in a plan view,
wherein a width of the linearly-formed resin of the air-permeable adhesive resin layer is 0.5 to 3 mm,
wherein a width of a gap between adjacent linearly-formed resins is 0.1 to 1 mm, and
wherein at least a part of the linearly-formed resin in a thickness direction is impregnated into the non-woven fabric layer.

2. (canceled)

3. The moisture-permeable waterproof sheet for building materials as recited in claim 1, wherein adjacent linearly-formed resins of the air-permeable adhesive resin layer are partially welded along a longitudinal direction of the linearly-formed resin.

4. The moisture-permeable waterproof sheet for building materials as recited in claim 1, wherein the air-permeable adhesive resin layer is formed by thermoplastic resin melt-extruded in a threadlike manner by an extruder.

5. The moisture-permeable waterproof sheet for building materials as recited in claim 1, wherein the non-woven fabric layer is a spunbonded non-woven fabric or a meltblown non-woven fabric.

6. The moisture-permeable waterproof sheet for building materials as recited in claim 5, wherein the spunbonded non-woven fabric is made of polyolefin.

7. The moisture-permeable waterproof sheet for building materials as recited in claim 1, further comprising a porous heat shielding layer laminated on an upper side of the porous polyolefin film layer, wherein the porous heat shielding layer includes a synthetic resin film and a deposited metallic film deposited on the synthetic resin film.

8. The moisture-permeable waterproof sheet for building materials as recited in claim 7, further comprising a synthetic resin protection layer laminated on an upper side of the porous heat shielding layer.

9. The moisture-permeable waterproof sheet for building materials as recited in claim 1, wherein;
a thermoplastic resin film is laminated on an upper side of the porous polyolefin film layer,
a deposited metallic film made of a glossy metallic material is provided on an upper side of the thermoplastic resin film,
a surface protection layer in which light-blocking particles are mixed in a transparent thermoplastic resin is laminated on an upper side of the deposited metallic film, and
a plurality of through-holes are formed so as to penetrate through a heat-shielding and anti-glare functional layer constituted by the thermoplastic resin film, the deposited metallic film, and the surface protection layer.

10. The moisture-permeable waterproof sheet for building materials as recited in claim 9, wherein an average particle diameter of the light-blocking particle is 5 to 300 nm.

11. The moisture-permeable waterproof sheet for building materials as recited in claim 9, wherein the light-blocking particle is an oxidized titanium particle.

12. The moisture-permeable waterproof sheet for building materials as recited in claim 9, wherein the surface protection layer contains 0.1 to 1.5 mass parts of the light-blocking particles with respect to 100 mass parts of the thermoplastic resin.

13. The moisture-permeable waterproof sheet for building materials as recited in claim 9, wherein a hole diameter of the through-hole is 0.3 to 0.7 mm, and wherein the through-holes are distributed at a rate of 500,000 to 1,000,000 holes/m².
